(19) United States
(12) Patent Application Publication
(10) Pub. No.: US 2009/0155082 A1
(43) Pub. Date: Jun. 18, 2009

(54) METHOD TO MAXIMIZE RESONANCE-FREE RUNNING RANGE FOR A TURBINE BLADE

(76) Inventors: Loc Duong, San Diego, CA (US); Ralph E. Gordon, San Diego, CA (US); Olivier J. Lamicq, Poway, CA (US)

Correspondence Address: CARLSON, GASKEY & OLDS, P.C., 400 WEST MAPLE ROAD, SUITE 350, BIRMINGHAM, MI, 48009, US

(21) Appl. No.: 11/958,585

(22) Filed: Dec. 18, 2007

(51) Int. Cl. F01D 5/14; B23P 15/00

(52) U.S. Cl. 416/223 A; 29/889.7

(57) ABSTRACT

An airfoil for a gas turbine engine component such as a turbine blade is tuned to move its natural frequency outside of a frequency which will be excited during expected speed range of an associated gas turbine engine. The airfoil is tuned about locations of the anti-nodes in an original airfoil design. The tuning affects only the interfered frequency.

### BACKGROUND OF THE INVENTION

This application relates to a method of modifying the profile of a turbine blade such that its interfered natural frequency will be outside of the operating envelope of the associated gas turbine engine while maintaining other frequencies unperturbed, and wherein the modification to the turbine blade occurs around an anti-node point.

Gas turbine engines are known, and typically include a plurality of sections mounted in series. One of the sections is a compressor section which has a rotor with a plurality of blades that rotate to compress air. The air is delivered into a combustion section where it is mixed with fuel and combusted. Products of this combustion pass downstream over a turbine section, to drive turbine rotors and associated blades. A good deal of design goes into the turbine blades, and into the compressor blades. The blades may be separately removable from the rotor, or the blades and the rotor may be formed integrally into a so-called integrally bladed rotor. In either case, the blades will have a natural frequency, and if the rotor operates at that frequency, there can be undesirable operational consequences.

It is generally known to modify the shape of the blades to move the natural frequency out of an operating speed range for a gas turbine engine. In general, the known methods have removed material at a preset or predetermined area to move the frequency.

### SUMMARY OF THE INVENTION

In a disclosed embodiment of this invention, the profile of a blade airfoil is modified to move the natural frequency outside of the operating envelope of the gas turbine engine, by modifying the airfoil about an identified anti-node point while maintaining other frequencies unperturbed.

These and other features of the present invention can be best understood from the following specification and drawings, the following of which is a brief description.

### BRIEF DESCRIPTION OF THE DRAWINGS

FIG. 1 shows an example turbine blade made according to this invention.

FIG. 2 is a chart showing aspects of the inventive method.

FIG. 3 is a flowchart.

### DETAILED DESCRIPTION OF A PREFERRED EMBODIMENT

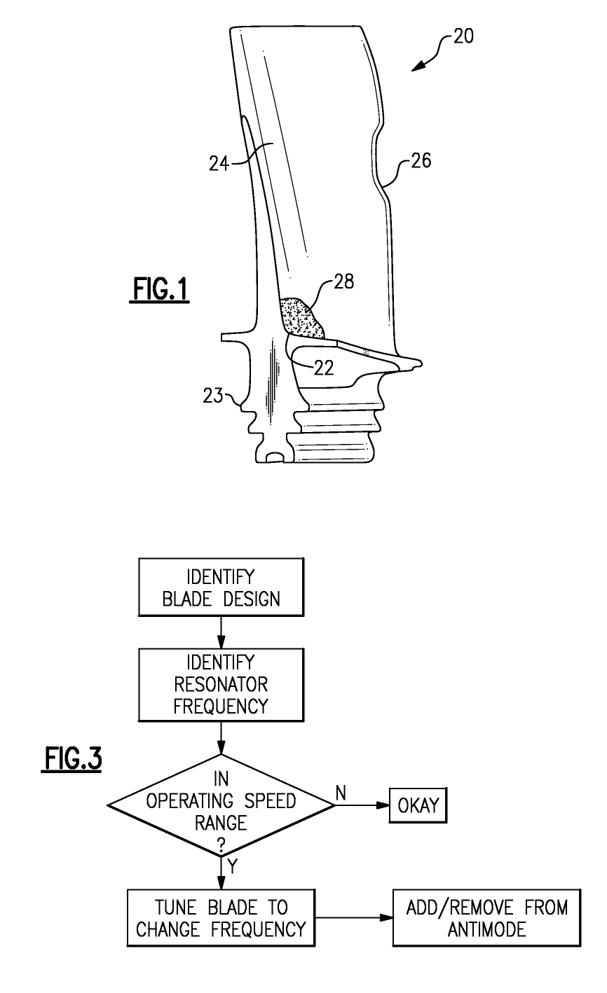

A turbine blade 20 is illustrated in FIG. 1. As known, a platform 22 includes root structure 23 for attaching a blade to a rotor. An airfoil 24 extends away from the platform 22. While a separately removable blade is illustrated, the present method would extend to blades which are formed integrally with a rotor.

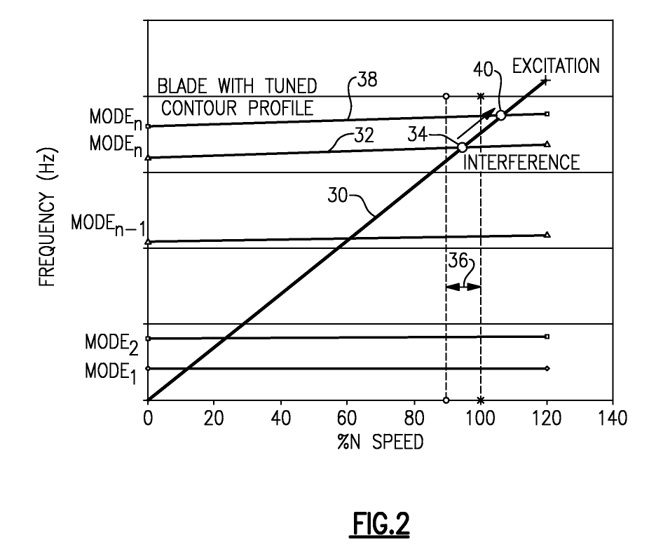

As shown, for example, in FIG. 2, every blade would have a natural frequency that is generally static as the speed of an associated gas turbine engine increases. An existing blade design, prior to the modification of this application, has its frequency plotted against the percentage speed of the engine at 32. The operating speed is shown by the line 30 increasing from zero, and upwardly showing the associated frequency as the speed increases. An operating speed range 36 is shown between approximately 90% and 100% of the speed. There is an interference point as illustrated at 34 between the lines 32 and 30. Thus, the initial design of a blade having the plot 32 would potentially move into a natural frequency during operation of a gas turbine engine.

The present invention includes a method of modifying that initial blade design to move its frequency mode to a line such as 38, where it would cross the line 30 at point 40, outside the speed range of the gas turbine engine. While the interference point 40 is shown above the operating speed range, it is also possible to find a point below the operating speed range. These aspects of the present invention may be generally as known in the art. Workers in this art would recognize how to move the natural frequency of a mass such as the turbine blade outside of the operating speed range. However, in the past, the modification to the blades has typically been done at predetermined or preset locations on the blades.

Applicant has identified a more desirable location for modifying the blades. Thus, as set forth for example in the flowchart of FIG. 3, an initial blade design is identified. The natural frequency of that blade design is identified. One then asks whether that frequency would have an interference point with the operational frequency of the engine within the normal operating speed range. If not, then no modification is necessary. However, if there is a potential interference within the expected operating speed range, then the blade must be tuned to change the frequency of the affected mode without disturbing the other non-interfered frequencies, for instance the intersection point between line 30 and the line defining Modeₙ₋₁ should remain unchanged as seen in FIG. 2.

The initial step in the present invention is to identify the anti-node locations. The anti-nodes of a mass which are moving into a natural frequency are typically the higher magnitudes of vibration. There may be more than one anti-node on a given airfoil design.

Then, the blade is tuned by localizing mass elements at the anti-nodes to maximize the resonance free running range. Finally, the contour profile geometry may be optimized to minimize stress concentrations.

Thus, returning to FIG. 1, a cutout 26 is illustrated on the airfoil 24, and additional material 28 is shown added to the airfoil 24. Either of these steps can be utilized to alter the natural frequency such that it moves outside of the operating speed range. The locations for the modifications 26 and 28, are identified as anti-nodes in the frequency of operation of the original blade design. A worker of ordinary skill in the art would recognize how to find the anti-nodes. As shown, material can be removed (26) or added (28).

Then, the contour profile is smoothed. As an example, as shown at 26 and 28, the profile is generally curved to minimize any stress concentration.

The material can be removed by grinding the contour via a formed wheel from a root form using data identified on the platform. A hand radius of the trailing edge after grinding the contour can be utilized as shown at 26. Also, CNC water jet profiling of the contour can be utilized and located as mentioned above, with hand radius smoothing of the trailing edge after cutting the contour.

By locating the tuned material at the anti-nodes, the present invention maximizes the resonance free running range of the frequency of interest without perturbing other non-interfered frequencies.

Although embodiments of this invention have been disclosed, a worker of ordinary skill in this art would recognize that certain modifications would come within the scope of this invention. For that reason, the following claims should be studied to determine the true scope and content of this invention.

What is claimed is:

1. A method of modifying the natural frequency of an airfoil for a gas turbine engine comprising the steps of:
a) identifying the natural frequency and identifying whether that frequency will occur during the normal operating speed range of an associated gas turbine engine;
b) identifying at least one anti-node of the airfoil; and
c) tuning the airfoil about the location of at least one anti-node to move an interfered natural frequency outside the expected operating speed range.

2. The method as set forth in claim 1, wherein the tuning occurs by removing material.

3. The method as set forth in claim 1, wherein the tuning material occurs by adding material.

4. The method as set forth in claim 1, wherein the tuned location is smoothed and ground such that it will be curved to reduce stress concentrations.

5. The method as set forth in claim 1, wherein the tuning affects only the frequency of interest without perturbing other non-interfered frequencies.

6. An airfoil for a gas turbine engine that has been tuned to move its natural frequency outside of an expected speed range of an associated gas turbine engine comprising:
a tuned area on the airfoil at the location of an anti-node.

7. The airfoil as set forth in claim 6, wherein the tuning occurs by removing material.

8. The airfoil as set forth in claim 6, wherein the tuning occurs by adding material.

9. The airfoil as set forth in claim 6, wherein the tuned location is smoothed and ground such that it will be curved to reduce stress concentrations.

10. The airfoil as set forth in claim 6, wherein the tuning affects only the frequency of interest without perturbing other non-interfered frequencies.
